(19) United States
(12) Patent Application Publication
(10) Pub. No.: US 2014/0001415 A1
(43) Pub. Date: Jan. 2, 2014

(54) Methods to Improve the Electrical Conductivity for Moulded Plastic Parts

(71) Applicants: Xia He Sheng, Chengdu (CN); Philip David Coates, Bradford (GB); Li Dong Xu, Chengdu (CN); Fei Guo Xia, Chengdu (CN); Gong Qi Chung, Chengdu (CN)

(72) Inventors: Xia He Sheng, Chengdu (CN); Philip David Coates, Bradford (GB); Li Dong Xu, Chengdu (CN); Fei Guo Xia, Chengdu (CN); Gong Qi Chung, Chengdu (CN)

(73) Assignees: University of Bradford, West Yorkshire (GB); Sichuan University, Chengdu (CN)

(21) Appl. No.: 13/977,773

(22) PCT Filed: Dec. 28, 2011
(86) PCT No.: PCT/GB2011/001775

§ 371 Date: Sep. 10, 2013

(30) Foreign Application Priority Data
Dec. 29, 2010 (CN) 201010611646.5
May 16, 2011 (GB) 1108161.9

(51) Int. Cl. H01B 1/04

(52) U.S. Cl. CPC H01B 1/04
USPC 252/511; 264/105

(57) ABSTRACT

Disclosed herein are the methods to improve the electrical conductivity for micro-moulded plastic parts containing carbon nanotubes. The polymer/carbon nanotubes composites suitable for polymer micromoulding including 80˜99.95 wt % of a polymer pellet or powder, 0-2 wt % of antioxidant, 0-2 wt % of dispersant agent and 0.05-20 wt % of carbon nanotube with a diameter 0.5-200 nm and a length of 200 nm-20 μm are firstly prepared through melt extrusion. The plastic microparts are prepared by micromoulding of the polymer/carbon nanotubes composites including micro extrusion, micro injection and hot embossing at optimized processing conditions and then are subject to a post thermal treatment to enhance the electrical conductivity. The post thermal treatment methods include electric heating, microwave, infrared or plasma heating. The methods disclosed can be used to prepare electrical conductive biomedical implanted plastic micro devices for minimally invasive surgery, biomedical sensors, microelectrodes, drug delivery devices, automated pipetting systems, breathing tubes, EMI devices etc.

### FIELD OF THE INVENTION

This invention describes methods to improve the electrical conductivity for moulded plastic parts containing carbon nanotubes.

Embodiments of the invention relate generally to the field of polymer processing. The disclosed methods are useful for devices such as, but not limited to, electrical conductive biomedical implanted plastic micro devices for minimally invasive surgery, biomedical sensors, microelectrodes, drug delivery devices, automated pipetting systems, breathing tubes, EMI devices etc.

### BACKGROUND OF THE INVENTION

The development of modern science and technology demands microdevices and microsystems with small size, light weight, high precision, high performance and multi-functions. The product weight can be reduced to milligrams and the size of some micro featured structures (micropore, microchannel, etc.) can reach as small as micron.

Their applications of such microdevices and microsystems are mainly involved in fields such as communication, electronics, bio-medical applications and micro electromechanics, etc., e.g. micro-gears with high precision, high strength, stable dimension and self-lubrication, micro photoelectrical information components with electrical, magnetic and photic functions and micro medical devices with biocompatibility, drug delivery and organ repair function, etc.

Polymers are easily thermally moulded due to the characteristics of a polymer's structure, performance and its sensitivity to temperature and pressure. The term moulded as used herein shall include conventional moulding that would be understood by the person skilled in the art. In addition, the term moulding shall include, inter alia, micro-moulding, i.e. very small (typically less than 1 mm) scale moulding, and thin-walled moulding. The micromoulding technology mainly based on polymer materials is developing rapidly and has been an important branch of micro-system technologies and is also a key topic in advanced manufacturing technologies. In some cases the traditional polymer materials have not been able to meet the moulding requirements of complicated and high precision microparts. Polymer materials with good excellent comprehensive performance such as high electrical conductivity, light weight, low cost, high mechanical strength, good flowability and lower thermal expansion coefficient are attracting much attention.

Carbon nanotubes (CNTs) are ideal reinforcing fibres for composite materials because they have a high aspect ratio, excellent mechanical strength, electrical and thermal conductivity and thermal stability, Compared to conventional carbon fibre or glass fibre, CNTs filled polymer composites are easily processed due to the small diameters of the CNTs. These materials can retain the polymer matrix properties (elasticity, strength and modulus) with the additional functionality of exceptionally high electrical and thermal conductivity. Novel CNTs/polymer composites open opportunities for new multi-functional materials with broad commercial and defence applications. Electrically conductive polymer/CNTs nanocomposites microparts have potential applications in the electronic and biomedical field such as EMI devices, drug delivery systems, microelectrodes, pipette tips, breathing tubes and structures etc.

Major challenges encountered in making such a composite are: (a) the uniform dispersion of CNTs in a polymer matrix without agglomerates and entanglements, and (b) CNTs/resin interface adhesion. Most electrical conductive polymer/CNTs nanocomposites are prepared by solution casting or thermal pressing. For moulded plastic parts of polymer/CNTs nanocomposites, it is difficult to obtain good electrical conductivity. Due to its high shear effect, the micromoulding process severely breaks down the conductive network and contact of CNTs, although, this process also facilitates the dispersion of CNTs in the polymer melt. Consequently, the electrical conductivity of moulded parts is much lower than a thermal pressed one. Also, there is significant difference in the electrical conductivity at different locations in the moulded parts caused by the effect of high shear gradient and temperature gradient. It is found that the electrical conductivity of the region close to mould gate is lower than that of region far away from the mould gate.

An aim of the present invention is to develop methods to improve the electrical conductivity for moulded plastic parts, e.g. micro-moulded and thin-walled moulded parts.

### SUMMARY OF THE INVENTION

According to an embodiment of the invention, there is a provided a polymer/carbon nanotube composite which is suitable for a polymer moulding process which comprises from 80 to 99.95 wt % of polymer pellets or powders, from 0 to 2 wt % of antioxidant, from 0 to 2 wt % of dispersion agent and from 0.05 to 20 wt % of carbon nanotubes.

The polymer/carbon nanotube is an electrical conductive polymer/carbon nanotube.

According to an embodiment of the invention there is a provided an electrical conductive plastic micropart which comprises a polymer/carbon nanotube composite which comprises from 80 to 99.95 wt % of polymer pellets or powders, from 0 to 2 wt % of antioxidant, from 0 to 2 wt % of dispersion agent and from 0.05 to 20 wt % of carbon nanotubes.

According to an embodiment of the invention there is a provided a process for the manufacture of electrical conductive plastic microparts which comprises:
(1) melt extruding a mixture of from 80 to 99.95 wt % of polymer pellets or powders, from 0 to 2 wt % of antioxidant, from 0 to 2 wt % of dispersion agent and from 0.05 to 20 wt % of carbon nanotubes to obtain a polymer/carbon nanotube composite;
(2) preparing plastic microparts by moulding of the polymer/carbon nanotubes composites obtained in the first step; and
(3) optionally subjecting the plastic microparts to a post thermal treatment to enhance the electrical conductivity.

Preferably, the step of subjecting the plastic microparts to a post thermal treatment to enhance the electrical conductivity is included in the process.

According to this embodiment of the invention, the processing steps and parameters for the electrical conductive plastic microparts are as follows:
(1) a mixture of from 80 to 99.95 wt % of polymer pellets or powders, from 0 to 2 wt % of antioxidant, from 0 to 2 wt % of dispersion agent and from 0.05 to 20 wt % of carbon nanotubes is melt extruded to obtain the polymer/carbon nanotube composite;
(2) the plastic microparts are prepared by moulding of the polymer/carbon nanotubes composites obtained in the first step; and
(3) the plastic microparts are subject to a post thermal treatment (annealing) to enhance the electrical conductivity.

The moulding process may involve very high strain rates and stresses, which break down the CNT conducting network, but such is necessary for producing a particular shape of product. However, this can be offset by including an annealing step. Products prepared by conventional moulding, high speed injection moulding, thin-walled moulding, may also benefit from including an annealing step.

According to this embodiment of the invention, the processing steps and parameters for the electrical conductive plastic microparts are as follows:
(1) a mixture of from 80 to 99.95 wt % of polymer pellets or powders, from 0 to 2 wt % of antioxidant, from 0 to 2 wt % of dispersion agent and from 0.05 to 20 wt % of carbon nanotubes was melt extruded through a micro extruder or a twin screw extruder to obtain the polymer/carbon nanotube composite. The extrusion may involve one to three passes of the material through the extruder. The processing temperature is between Tm+10° C. to Tm+60° C. (Tm is the melting point of polymer), and the screw speed is set at between 20 rpm to 300 rpm.
(2) The plastic microparts are prepared by moulding of the polymer/carbon nanotubes composites obtained in the first step including micro extrusion, micro injection moulding and hot embossing at from Tm+10° C. to Tm+80° C. for from 20s to 20 min, then the micro products were cooled for from 5 s to 20 min at a temperature from room temperature to Tm−5° C. For micro injection moulding and hot embossing, the mould for shaping is made of metal, plastic or ceramics, in preferred embodiments, the mould is made of plastic or ceramics which can cool slower. The mould temperature was set at a certain temperature between room temperature to Tm−5° C., in preferred embodiments, the mould temperature is set at Tm−50° C., and the pack time is set at from 5s to 20min. A higher mould temperature is better. For micro extrusion process, the cooling medium of extrudates are hot air or water bath with a temperature between room temperature to Tm−5° C. for from 5 s to 20 min, in preferred embodiments, temperature is set at Tm−50° C. The cooling can be two or multi-stages and a higher temperature of cooling medium is better.
(3) The plastic microparts are subject to a post thermal treatment to enhance the electrical conductivity. The post thermal treatment methods include electric heating, microwave, infrared or plasma heating. For the isothermal treatment, the plastic parts are kept in an oven at a certain temperature between 50° C. to Tm−5° C. for from 5 s to 1.5 h. For the non-isothermal treatment, the plastic parts are heated from room temperature to Tm−5° C. for from 3 min to 1.5 h with a heating rate of 1° C. to 20° C. per minute. For microwave treatment, the plastic parts are kept in a microwave oven at a power of from 20 to 500 W for from 5 s to 0.5 h. For infrared heating treatment, the plastic part is kept in a chamber at a power of from 50 to 1000 W for from 5 s to 0.5h. For plasma heating treatment, the plastic part is kept in a chamber at a power of from 50 to 600 W to for from 5 s to 0.5 h.

According to an embodiment of the invention, the polymer used in the preparation of electrical conductive polymer/carbon nanotube composites is selected from one or more of polyethylene, polystyrene, polyvinylchloride, polypropylene, polyoxymethylene, polymethyl methacrylate, polybutyl acrylate, polymethyl methacrylate-butyl acrylate copolymer, polylactic acid, polylactic acid-polyethylene glycol copolymer, nylon 6, nylon 66, ABS resin, polyetheretherketone, liquid crystal polymer, polybutylene terephthalate, polyethylene terephthalate, polycarbonate and thermoplastic polyurethane.

According to an embodiment of the invention, the carbon nanotube used in the preparation of electrical conductive polymer/carbon nanotube composites is a multi-walled carbon nanotube or a single wall carbon nanotube. The aforementioned carbon nanotube may have a dimension of from 0.5 to 200 nm in diameter and from 200 nm to 20 μm in length.

According to an embodiment of the invention, there is provided the composite as hereinbefore described wherein the antioxidant used in the preparation of electrical conductive polymer/carbon nanotube composites is selected from one or more of diphenylamine, p-phenylenediamine, dihydroquinoline, phosphate and a hindered phenol (a hindered phenol will be understood to be a phenolic stabilizers that is a primary antioxidants that acts as a hydrogen donor).

According to an embodiment of the invention, the dispersion agent used in the preparation of electrical conductive polymer/carbon nanotube composites is selected from one or more of tristearin, calcium stearate, ethylene-acrylic acid copolymer, ethylene vinyl acetate copolymer and cetyl trimethyl ammonium bromide.

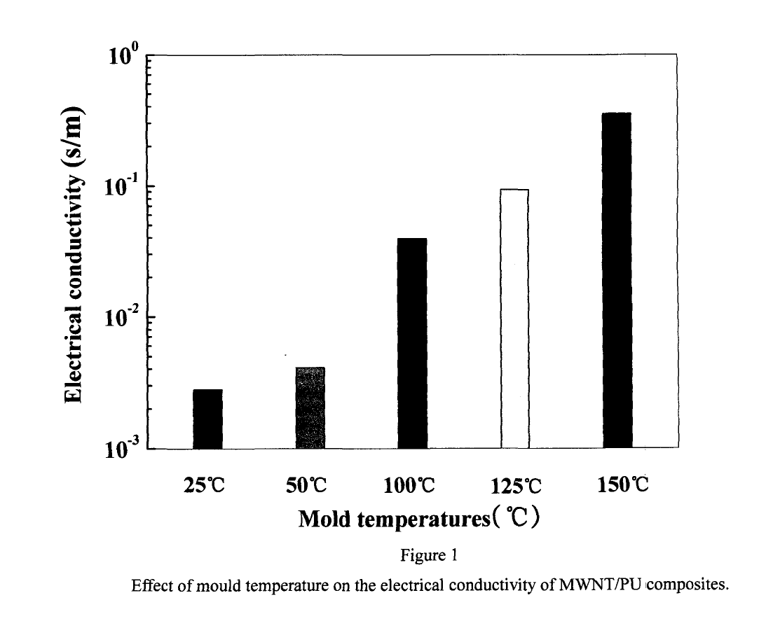

The invention will now be described by way of example only and with reference to the accompanying figures in which FIG. 1 shows the effect of mold temperature on the electrical conductivity of MWNT/PU composites; and

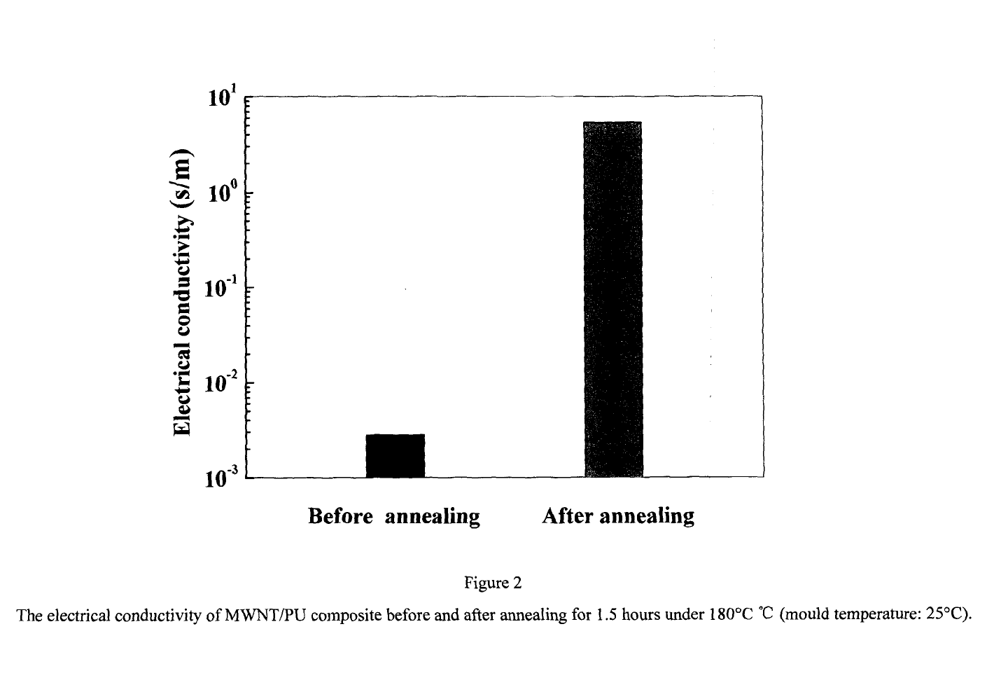

FIG. 2 shows the electrical conductivity of MWNT/PU composite before and after annealing for 1.5 hours under 180° C. (mold temperature: 25° C.).

### EXAMPLES

### Example 1

(1) Multi-walled Carbon Nanotube (MWNT)

MWNT (Product number: C7000) with a diameter of 15 nm, product of Nanocyl, Belgium was used.

(2) Thermoplastic polyurethane elastomer (PU)

PU (Product number: ESA-480) with shore hardness 80A, product of Shenzhen Pepson Company, China was used.

Firstly, 30 g MWNT and 270 g dried pelletized PU were firstly well mixed and then blended in a twin-screw extruder (L/D: 36, model: SHJ-25, Nanjing ChengMeng Plastics Machinery Industry Company, Ltd, China) in the range of 185-195° C. and a screw speed of 120 rpm. The extrudate was quenched in a water bath, cut into pellets and then dried in a vacuum oven at 100° C. for 8 h. The MWNT/PU masterbatch with 10 wt % MWNT were prepared.

Secondly, 200 g of pellets of this master batch and 200 g PU were blended in the twin-screw extruder again under the same processing conditions as the first step. The extrudate was quenched in a water bath, cut into pellets, and dried in a vacuum oven at 100° C. for 8 h. The MWNT/PU nanocomposites with 5 wt % MWNT content were produced.

Thirdly, the composites were micro injection moulded through a HAAKE MiniJet machine. The micro injection moulding process was performed at a cylinder temperature of 210° C. an injection time of 10 s, an injection pressure of 77 MPa, a holding pressure of 20 MPa, a holding time of 10 seconds and the mould temperature was set at 25, 50, 75, 125, and 150° C. FIG. 1 shows the effect of mould temperature on the electrical conductivity of MWNT/PU composites. As the mould temperature increased from 25° C. to 150° C., the average electrical conductivity of tested samples increased from 0.0028 s/m to 0.3526 s/m.

The electrical conductivity of all samples was measured by a simple two-point measurement with a picoameter (Keithley 2400). Electrodes were painted onto the rectangle sample strip moulded by above process using silver epoxy paste. The measured volume resistance (Rv) was converted to volume resistivity (ρᵥ) and conductivity (σᵥ) according to ASTM D4496 and D257 using the formula:

$$\begin{matrix}{ρ}_{v} \approx {R}_{v} \frac{A}{t} & ( 1 ) \\ {σ}_{v} \approx 1 / {ρ}_{v} & ( 2 )\end{matrix}$$

Where A is effective area of the measuring electrode (m²) and t is specimen thickness (m).

### Example 2

MWNT/PU composites were prepared as the same process in Example 1. The composites were micro injection moulded through a HAAKE MiniJet machine. The micro injection moulding process was conducted at a cylinder temperature of 210° C., an injection time of 10 s, an injection pressure of 77 MPa, a holding pressure of 20 MPa, a holding time of 10 seconds and a mould temperature of 25° C., The post thermal treatment was as follows: the micro injection moulded plastic parts were subject to thermal annealing treatment for 1.5 hours at 180° C. in an electric resistive heating oven. The electrical conductivity of micromoulded plastic parts is about 5.4 S. m⁻¹. FIG. 2 shows the electrical conductivity of MWNT/PU composites before and after annealing for 1.5 hours under 180° C. The electrical conductivity of the MWNT/PU composite increased from 0.0028 s/m to 5.3597 s/m after annealing for 1.5 hours under 180° C.

### Example 3

15 g MWNT, 2 g diphenylamine, tristearin 2 g and 270 g high density polyethylene (HDPE, SH800, China petroleum & chemical corporation) with a melt flow index of 8.0 g/10 min were firstly mixed and then blended in a twin-screw extruder in the temperature range of 185-195° C. and a screw speed of 120 rpm. The extrudate was quenched in a water bath, cut into pellets and then dried in a vacuum oven at 100° C. for 2 h. Then the pellets were micro injection moulded through a HAAKE MiniJet machine at a cylinder temperature of 210° C., an injection time of 10 s, an injection pressure of 77 MPa, a holding pressure of 20 Mpa, a holding time of 10 seconds and a mould temperatures of 25° C. The post thermal treatment was as follows: the micro injection moulded plastic parts were subject to thermal annealing treatment for 1.5 hours at 180° C. in an electric resistive heating oven. The electrical conductivity of the micro injection moulded MWNT/HDPE sample is ˜30S. m⁻¹.

### Example 4

1.6 g MWNT, 0.7 g p-Phenylenediamine, 0.8 g calcium stearate and 27 g PP (T30s Dushanzi Petrochemical Corporation, China,) with a melt flow index of 3.4 g/10 min was supplied by were firstly mixed and then blended in a micro-twin-screw extruder (HAAKE MiniLab) at 195° C., a screw speed of 120 rpm and a circulative time of 1 min. The extrudate was quenched and cut into pellets. Then the pellets were micro injection moulded through a HAAKE MiniJet machine at a cylinder temperature of 210° C., an injection time of 10 s, an injection pressure of 77 MPa, a holding pressure of 20 Mpa, a holding time of 50 seconds and a mould temperature of 25° C. The post thermal treatment was as follows: the micro injection moulded plastic parts were subject to thermal annealing treatment for 1.5 hours at 175° C. in an electric resistive heating oven. The electrical conductivity of the sample is ˜0.9S. m⁻¹.

### Example 5

15 g MWNT, 3 g ethylene-acrylic acid copolymer and 270 g PC (201-10, Dow Chemical, USA) were firstly mixed and then blended in a twin-screw extruder twice in the range of 265-280° C. and a screw speed of 50 rpm. The extrudate was quenched in a water bath, cut into pellets and then dried in a vacuum oven at 100° C. for 8 h. Then the pellets were micro injection moulded at a cylinder temperature of 280° C., an injection time of 10 s, an injection pressure of 77 MPa, a holding pressure of 20 MPa, a holding time of 100 seconds and a mould temperatures of 25° C. in a HAAKE Minijet machine. The post thermal treatment was as follows: the micro injection moulded plastic parts were subject to thermal annealing treatment for 1 hours at 180° C. in an electric resistive heating oven. The electrical conductivity of the sample is ˜1.29S. m⁻¹.

### Example 6

30 g MWNT, 3 g dihydroquinoline and 540 g PMMA powder (IF850, LG Chemical, Korea) were firstly mixed and then blended in a twin-screw extruder in the range of 200-220° C. and a screw speed of 50 rpm. The extrudate was quenched in a water bath, cut into pellets and then dried in a vacuum oven at 100° C. for 8 h. Then the pellets were blended again in a micro-twin-screw extruder (HAAKE MiniLab) at 250° C., a screw speed of 120 rpm and a circulative time of 5 min. The extrudate was quenched and cut into pellets. Then the pellets were micro injection moulded at a cylinder temperature of 200° C., an injection time of 10 s, an injection pressure of 77 MPa, a holding pressure of 20 MPa, a holding time of 10 seconds and a mould temperature of 25° C. in a HAAKE minijet machine. The post thermal treatment was as follows: the micro injection moulded plastic parts were subject to thermal annealing treatment for 1 hours at 120° C. in an electric resistive heating oven. The electrical conductivity of the sample is ˜3.35S. m⁻¹.

### Example 6

20 g MWNT and 500 g PLA (Ingeo3251D, Nature Works) were firstly mixed and then blended in a twin-screw extruder in the range of 200-220° C. and a screw speed of 120 rpm. The extrudate was quenched in a water bath, cut into pellets and then dried in a vacuum oven at 100° C. for 8 h. Then the pellets were blended again in a micro-twin-screw extruder (HAAKE MiniLab) at 195° C., a screw speed of 120 rpm and a retention time of 20 s. The extrudate was quenched in a water bath at 25° C., cut into long straight stripe and then dried in a vacuum oven at room temperature for 24 h. The electrical conductivity of the stripe sample is ˜0.65 S. m⁻¹.

### Example 7

30 g MWNT and 270 g dried pelletized PU(ESA-480, Shenzhen Pepson Company) with a shore hardness 80A were firstly mixed and then blended in a twin-screw extruder (LID: 36, model: SHJ-25, Nanjing ChengMeng Plastics Machinery Industry Company, Ltd, China) in the range of 185-195° C. and a screw speed of 120 rpm. The extrudate was quenched in a water bath, cut into pellets and then dried in a vacuum oven at 100° C. for 8 h. The MWNT/PU masterbatch with 10 wt % MWNT were prepared. Then, 200 g this masterbatch pellets and 200 g PU were blended in the twin-screw extruder again under the same processing conditions as the first step. The extrudate was quenched in a water bath, cut into pellets, and dried in a vacuum oven at 100° C. for 8 h. The MWNT/PU nanocomposites with 5 wt % MWNT content were produced. After that, the composites were micro injection moulded. The micro injection moulding process was conducted at a cylinder temperature of 210° C., an injection time of 10 s, an injection pressure of 77 MPa, a holding pressure of 20 MPa, a holding time of 10 seconds and a mould temperatures of 25° C. in a HAAKE miniJet machine This micro injection moulded sample was treated in a microwave oven at 750 w for 0.5 hours. The electrical conductivity of the treated sample is ˜0.5 S. m⁻¹.

### Example 8

30 g MWNT, 5 g cetyl trimethyl ammonium bromide, 5 g hindered phenol and 250 g dried pelletized PU (ESA-480, Shenzhen Pepson Company) with a shore hardness 80A were well mixed and then blended in a twin-screw extruder (L/D: 36, model: SHJ-25, Nanjing Chengmeng Plastics Machinery Industry Company, Ltd, China) in the range of 185-195° C. and a screw speed of 120 rpm. The extrudate was quenched in a water bath, cut into pellets and then dried in a vacuum oven at 100° C. for 8 h. The MWNT/PU masterbatch with 10 wt % MWNT were prepared. Then, 200 g this masterbatch pellets and 200 g PU were blended in the twin-screw extruder again under the same processing conditions as the first step. The extrudate was quenched in a water bath, cut into pellets, and dried in a vacuum oven at 100° C. for 8 h. The MWNT/PU nanocomposites with 5 wt % MWNT content were produced. After that, the composites were micro injection moulded. The micro injection moulding process was performed at a cylinder temperature of 210° C., an injection time of 10 s, an injection pressure of 77 MPa, a holding pressure of 20 MPa, a holding time of 10 seconds and a mould temperatures of 25° C. in a HAAKE miniJet machine. This micro injection moulded sample was heated by Infrared heater at 1000 w for 1 hour. The electrical conductivity of treated sample is ˜0.56 S. m⁻¹.

1. A polymer/carbon nanotube composite which is suitable for a polymer moulding process which comprises from 80 to 99.95 wt % of polymer pellets or powders, from 0 to 2 wt % of antioxidant, from 0 to 2 wt % of dispersion agent and from 0.05 to 20 wt % of carbon nanotubes.

2. The polymer composite according to claim 1, wherein the polymer used in the preparation of electrical conductive polymer/carbon nanotube composite is selected from one or more of polyethylene, polystyrene, polyvinylchloride, polypropylene, polyoxymethylene, polymethyl methacrylate, polybutyl acrylate, polymethyl methacrylate-butyl acrylate copolymer, polylactic acid, polylactic acid-polyethylene glycol copolymer, nylon 6, nylon 66, ABS resin, polyetheretherketone, liquid crystal polymer, polybutylene terephthalate, polyethylene terephthalate, polycarbonate and thermoplastic polyurethane.

3. The polymer composite according to claim 1, wherein the carbon nanotube used in the preparation of electrical conductive polymer/carbon nanotube composite is multi-walled carbon nanotube or single wall carbon nanotube with a dimension of from 0.5 to 200 nm in diameter and from 200 nm to 20 μm in length.

4. The polymer composite according to claim 1, wherein the antioxidant used in the preparation of electrical conductive polymer/carbon nanotube composite is selected from one or more of diphenylamine, p-phenylenediamine, dihydroquinoline, phosphate and hindered phenol.

5. The polymer composite according to claim 1, wherein the dispersion agent used in the preparation of electrical conductive polymer/carbon nanotube composite is selected from one or more of tristearin, calcium stearate, ethylene-acrylic acid copolymer, ethylene vinyl acetate copolymer and cetyl trimethyl ammonium bromide.

6. An electrical conductive plastic micropart which comprises a polymer/carbon nanotube composite which comprises from 80 to 99.95 wt % of polymer pellets or powders, from 0 to 2 wt % of antioxidant, from 0 to 2 wt % of dispersion agent and from 0.05 to 20 wt % of carbon nanotubes.

7. The electrical conductive plastic micropart according to claim 6, wherein the polymer used in the preparation of electrical conductive polymer/carbon nanotube composite is selected from one or more of polyethylene, polystyrene, polyvinylchloride, polypropylene, polyoxymethylene, polymethyl methacrylate, polybutyl acrylate, polymethyl methacrylate-butyl acrylate copolymer, polylactic acid, polylactic acid-polyethylene glycol copolymer, nylon 6, nylon 66, ABS resin, polyetheretherketone, liquid crystal polymer, polybutylene terephthalate, polyethylene terephthalate, polycarbonate and thermoplastic polyurethane.

8. The electrical conductive plastic micropart according to claim 6, wherein the carbon nanotube used in the preparation of electrical conductive polymer/carbon nanotube composite is multi-walled carbon nanotube or single wall carbon nanotube with a dimension of from 0.5 to 200 nm in diameter and from 200 nm to 20 μm in length.

9. The electrical conductive plastic micropart according to claim 6, wherein the antioxidant used in the preparation of electrical conductive polymer/carbon nanotube composite is selected from one or more of diphenylamine, p-phenylenediamine, dihydroquinoline, phosphate and hindered phenol.

10. The electrical conductive plastic micropart according to claim 6, wherein the dispersion agent used in the preparation of electrical conductive polymer/carbon nanotube composite is selected from one or more of tristearin, calcium stearate, ethylene-acrylic acid copolymer, ethylene vinyl acetate copolymer and cetyl trimethyl ammonium bromide.

11. A process for the manufacture of electrical conductive plastic microparts which comprises:
(1) melt extruding a mixture of from 80 to 99.95 wt % of polymer pellets or powders, from 0 to 2 wt % of antioxidant, from 0 to 2 wt % of dispersion agent and from 0.05 to 20 wt % of carbon nanotubes to obtain a polymer/carbon nanotube composite;
(2) preparing plastic microparts by moulding of the polymer/carbon nanotubes composites obtained in the first step; and
(3) optionally subjecting the plastic microparts to a post thermal treatment to enhance the electrical conductivity.

12. The process according to claim 11 wherein the extrusion passes can be 1-3 times; the processing temperature is between Tm+10° C. to Tm+60° C. (Tm is the melting point of polymer), and the screw speed is set at between 20 rpm to 300 rpm.

13. The process according to claim 11 wherein the plastic microparts moulding includes extrusion, injection moulding and/or hot embossing at from Tm+10° C. to Tm+80° C. for from 20s to 20 min, then the micro products were cooled for from 5 s to 20 min at a temperature from room temperature to Tm−5° C.

14. The process according to claim 13 wherein the plastic micro parts moulding includes micro-extrusion, micro-injection moulding and/or hot embossing at from Tm+10° C. to Tm+80° C. for from 20 s to 20 min, then the micro products were cooled for from 5 s to 20 min at a temperature from room temperature to Tm−5° C.

15. The process according to claim 11 wherein the post thermal treatment methods include electric heating, microwave, infrared or plasma heating.

16. The process according to claim 11, wherein the polymer used in the preparation of electrical conductive polymer/carbon nanotube composite is selected from one or more of polyethylene, polystyrene, polyvinylchloride, polypropylene, polyoxymethylene, polymethyl methacrylate, polybutyl acrylate, polymethyl methacrylate-butyl acrylate copolymer, polylactic acid, polylactic acid-polyethylene glycol copolymer, nylon 6, nylon 66, ABS resin, polyetheretherketone, liquid crystal polymer, polybutylene terephthalate, polyethylene terephthalate, polycarbonate and thermoplastic polyurethane.

17. The process according to claim 11, wherein the carbon nanotube used in the preparation of electrical conductive polymer/carbon nanotube composite is multi-walled carbon nanotube or single wall carbon nanotube with a dimension of from 0.5 to 200 nm in diameter and from 200 nm to 20 μm in length.

18. The process according to claim 11, wherein the antioxidant used in the preparation of electrical conductive polymer/carbon nanotube composite is selected from one or more of diphenylamine, p-phenylenediamine, dihydroquinoline, phosphate and hindered phenol.

19. The process according to claim 11, wherein the dispersion agent used in the preparation of electrical conductive polymer/carbon nanotube composite is selected from one or more of tristearin, calcium stearate, ethylene-acrylic acid copolymer, ethylene vinyl acetate copolymer and cetyl trimethyl ammonium bromide.

20. (canceled)
